(19) United States
(12) Patent Application Publication
(10) Pub. No.: US 2022/0343485 A1
(43) Pub. Date: Oct. 27, 2022

(54) VIDEO QUALITY ESTIMATION APPARATUS, VIDEO QUALITY ESTIMATION METHOD AND PROGRAM

(71) Applicant: Nippon Telegraph and Telephone Corporation, Tokyo (JP)

(72) Inventors: Yuichiro Urata, Musashino-shi, Tokyo (JP); Masanori Koike, Musashino-shi, Tokyo (JP); Kazuhisa YAMAGISHI, Musashino-shi, Tokyo (JP)

(21) Appl. No.: 17/762,575

(22) PCT Filed: Oct. 2, 2019
(86) PCT No.: PCT/JP2019/038983

§ 371 Date: Mar. 22, 2022

(51) Int. Cl. G06T 7/00; G10L 25/60

(52) U.S. Cl. CPC G06T 7/0002; G10L 25/60; G06T 2207/10016

(57) ABSTRACT

A video quality estimation apparatus for estimating an experienced quality of a user when viewing a video includes a video quality estimation unit that estimates a video quality based on a parameter related to video quality of a high image quality region in the video and a parameter related to video quality of a low image quality region in the video, an audio quality estimation unit that estimates audio quality from a parameter related to audio quality of the video,

an audio-visual quality/quality variation integration unit that estimates audio-visual quality based on a video quality estimation value estimated by the video quality estimation unit and an audio quality estimation value estimated by the audio quality estimation unit, a degradation amount estimation unit that estimates a degradation amount of the experienced quality based on a parameter related to the stop of replay of the video, the degradation being caused by a stop of replay, and a quality integration unit that estimates the experienced quality in viewing based on the audio-visual quality estimated by the audio-visual quality/quality variation integration unit and the degradation amount caused by the stop of replay estimated by the degradation amount estimation unit.

### TECHNICAL FIELD

The present invention relates to a technique to evaluate the quality of a virtual reality (VR) video.

### BACKGROUND ART

In recent years, VR video distribution services and content that enable 360-degree viewing have increased due to the development of VR technologies, and opportunities for users to view VR videos using smartphones, tablet terminals, PCs, HMDs, and the like have increased as well.

Visualization of the quality of a service is important because service quality varies greatly according to time slots and the like when a service is provided via a best-effort network. Thus, a quality estimation technique aimed at quality monitoring in video distribution, web browsing, voice calls, and the like has been established.

On the other hand, although VR video distribution services that enable users to view in all directions of 360 degrees have become widespread in recent years in association with high performance of cameras, high definition and miniaturization of displays, advances in video processing technologies, and the like, a quality estimation technique for VR video distribution has not been established.

VR video distribution requires a high bit-rate in order to deliver a high-resolution 360-degree video. For this reason, tile-based distribution that helps reduce distribution costs by distributing regions displayed on a display in a user's viewing direction at a high bit-rate and distributing other videos not displayed on the display at a low bit-rate or not distributing the other videos, with no need to encode and distribute an entire video with uniform quality as in 2D video distribution services, has become mainstream.

NPL 1 and NPL 2 propose encoding methods in which an entire video is divided into tiles, each tile is encoded at a high bit-rate (high image quality tiles) and the resolution of the entire video is reduced to be encoded at a low bit-rate (low image quality tiles). In this related-art method, high image quality tiles in the user's viewing direction and low image quality tiles including the entire video are distributed.

In such tile-based distribution, adaptive bit-rate video distribution such as MPEG-DASH, etc., is also used. In the adaptive bit-rate video distribution, distribution is performed while switching the bit-rate level in order to avoid a stop of replay caused by a reduced throughput or buffer depletion of the reception terminal as much as possible. NPL 3 describes tile-based adaptive bit-rate video distribution in which a 360-degree video is divided into tiles and the video of the divided regions is encoded and distributed at multiple bit-rates.

As described above, in the tile-based VR video distribution, the low image quality tiles are displayed while new high image quality tiles are downloaded because the downloading is needed as the user changes a viewing region. In addition, variation in a selected bit-rate or a stop of replay occurs due to a throughput and buffer depletion. In order to perform quality monitoring in VR video distribution as described above, a quality estimation technique considering quality degradation associated with switching between high image quality and low image quality, image quality degradation caused by bit-rate variation, and a stop of replay is needed.

NPL 4 and NPL 5 discuss quality estimation for VR videos, and in particular, quality estimation for tile-based VR videos. NPL 4 proposes a quality estimation technique based on information of viewing regions and information of media layers, and NPL 5 proposes a quality estimation technique using information (quantization parameters) of bit stream layers of high image quality tiles and low image quality tiles.

However, NW apparatuses and reception terminals are required to estimate quality with a low computational complexity in quality monitoring. Thus, the capability to easily calculate quality using meta information such as a bit-rate has become a requirement, and a quality estimation technique using information of media or bit streams is not suitable. Furthermore, the above proposed techniques have a problem in that the influence of bit-rate variation and a stop of replay are not taken into account. The ITU-T Recommendation P.1203 (NPL 6 to NPL 9) has been standardized as a quality estimation technique taking bit-rate variation and a stop of replay into account for implementing quality monitoring.

### CITATION LIST

### Non Patent Literature

NPL 1: H. Kimata, D. Ochi, A. Kameda, H. Noto, K. Fukazawa, and A. Kojima, “Mobile and Multi-Device Interactive Panorama Video Distribution System”, The 1st IEEE Global Conference on Consumer Electronics 2012, Tokyo, 2012, pp. 574-578.
NPL 2: D. Ochi, Y. Kunita, A. Kameda, A. Kojima, S. Iwaki, “Live Streaming System for Omnidirectional Video”, Proc. of IEEE Virtual Reality (VR), 2015.
NPL 3: Jean Le Feuvre, Cyril Concolato, “Tiled-based Adaptive Streaming using MPEG-DASH”, MMSys '16 Proceedings of the 7th International Conference on Multimedia Systems, Article No. 41
NPL 4: C. Ozcinar, J. Cabrera, and A. Smolic, “Visual Attention-Aware Omnidirectional Video Streaming Using Optimal Tiles for Virtual Reality”, IEEE Journal on Emerging and Selected Topics in Circuits and Systems, vol. 9, no. 1, pp. 217-230, 2019.
NPL 5: M. Koike, Y. Urata, K. Yamagishi, “A Study on Objective Quality Estimation Model for Tile-based VR video Streaming Services”, IEICE Technical Report, vol. 118, no. 503, CQ2018-102, pp. 55-59, March 2019.
NPL 6: Parametric Bitstream-based Quality Assessment of Progressive Download and Adaptive Audiovisual Streaming Services over Reliable Transport, Recommendation ITU-T P. 1203, 2017.

NPL 7: Parametric Bitstream-based Quality Assessment of Progressive Download and Adaptive Audiovisual Streaming Services over Reliable Transport-Video Quality Estimation Module, Recommendation ITU-T, P.1203.1, 2017.

NPL 8: Parametric Bitstream-based Quality Assessment of Progressive Download and Adaptive Audiovisual Streaming Services over Reliable Transport-Audio Quality Estimation Module, Recommendation ITU-T, P.1203.2, 2017.

NPL 9: Parametric Bitstream-based Quality Assessment of Progressive Download and Adaptive Audiovisual Streaming Services over Reliable Transport-Quality Integration Module, Recommendation ITU-T, P.1203.3, 2019.

### SUMMARY OF THE INVENTION

### Technical Problem

However, in the quality estimation methods for 2D videos described in NPL 6 to NPL 9, quality variation associated with a change in a viewing region is not considered. While a 2D video has one video quality at a viewing time even though the quality varies according to band variation, it is likely in a tile-based VR video that not only high image quality regions but also low image quality regions are viewed according to a change in a viewing direction, and thus the video qualities of the both regions need to be considered.

The present invention has been made in view of the aforementioned points, and aims to provide a technique that enables the quality of a tile-based and adaptively distributed VR video experienced by a user when viewing the video to be estimated in consideration of quality variation associated with a change of viewing regions.

### Means for Solving the Problem

According to the disclosed technique, a video quality estimation apparatus is provided to estimate a quality experienced by a user when viewing a video, the video quality estimation apparatus including a video quality estimation unit that estimates video quality based on a parameter related to video quality of a high image quality region in the video and a parameter related to video quality of a low image quality region in the video, an audio quality estimation unit that estimates audio quality from a parameter related to audio quality of the video, an audio-visual quality/quality variation integration unit that estimates audio-visual quality based on a video quality estimation value estimated by the video quality estimation unit and an audio quality estimation value estimated by the audio quality estimation unit,

a degradation amount estimation unit that estimates a degradation amount of the experienced quality based on a parameter related to the stop of replay of the video, the degradation being caused by a stop of replay, and a quality integration unit that estimates the experienced quality in viewing based on the audio-visual quality estimated by the audio-visual quality/quality variation integration unit and the degradation amount caused by the stop of replay estimated by the degradation amount estimation unit.

### Effects of the Invention

According to the disclosed technique, a technique that enables quality of a tile-based and adaptively distributed VR video experienced by a user when viewing the video to be estimated in consideration of quality variation associated with a change of viewing regions is provided.

### BRIEF DESCRIPTION OF DRAWINGS

FIG. 1 is a configuration diagram of a VR video quality estimation apparatus according to an embodiment of the present invention.

FIG. 2 is a diagram illustrating an example of input parameters to a high image quality region video quality estimation unit 11 according to an embodiment of the present invention.

FIG. 3 is a diagram illustrating an example of a hardware configuration of the VR video quality estimation apparatus according to an embodiment of the present invention.

FIG. 4 is a flowchart of a video quality estimation method performed by the VR video quality estimation apparatus according to an embodiment of the present invention.

### DESCRIPTION OF EMBODIMENTS

Hereinafter, embodiments of the present invention will be described with reference to the drawings. The embodiments to be described below is merely an example, and embodiments to which the present invention are applied are not limited to the following embodiments. Although VR videos are objects in the following description of embodiments, the present invention can be applied to not only VR videos but also videos having a high image quality region and a low image quality region.

In the following embodiments, a VR video quality estimation apparatus that estimates a quality value of a VR video (video quality value) that a user experiences when he or she views the VR video in which the user can look through 360 degrees in a state in which the line-of-sight direction can be changed by the user wearing a head-mounted display (HMD) or the like, and making a motion such as turning his or her neck or moving his or her body, or in a state in which the video viewing direction can be changed by operating a conventional stationary display with a mouse or the like will be described.

Hereinafter, a first embodiment and a second embodiment will be described. In the first embodiment and the second embodiment, the VR video is tile-based and is subject to adaptive bit-rate distribution. In addition, the high image quality regions described below are, for example, high image quality tiles, and the low image quality regions are, for example, low image quality tiles. Furthermore, a method for acquiring parameters input to the VR video quality estimation apparatus 1 is not limited to a specific one. For example, parameters can be acquired from a video distribution server. In addition, a “video” that a user views is assumed to also include sound.

### First Embodiment

Configuration of Apparatus

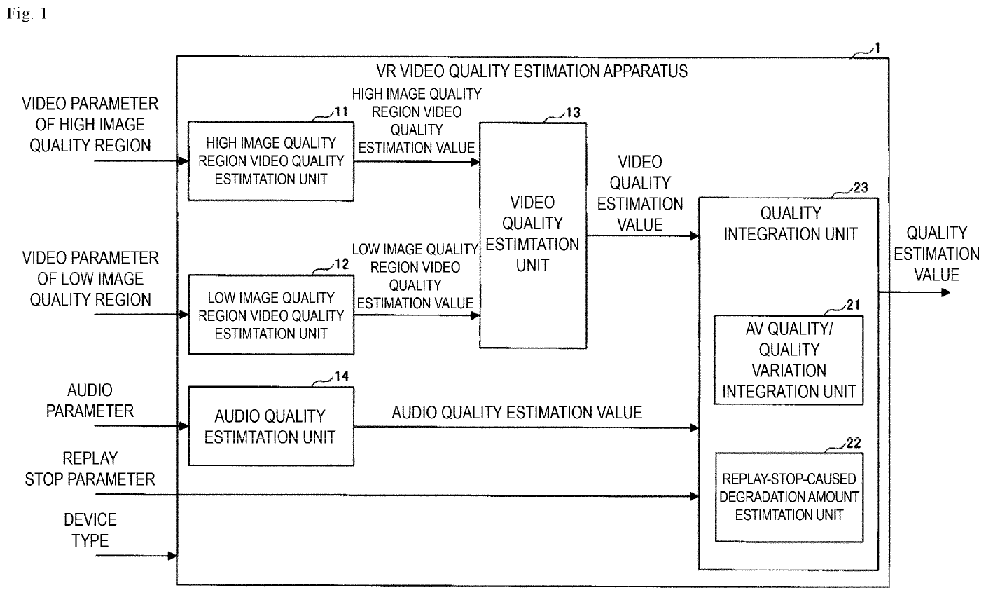

FIG. 1 illustrates a configuration of the VR video quality estimation apparatus 1 according to a first embodiment. As illustrated in FIG. 1, the VR video quality estimation apparatus 1 includes a high image quality region video quality estimation unit 11, a low image quality region video quality estimation unit 12, a video quality estimation unit 13, an audio quality estimation unit 14, and a quality integration unit 23. The quality integration unit 23 includes an audio-visual (AV) quality/quality variation integration unit 21, and a replay-stop-caused degradation amount estimation unit 22. Further, the VR video quality estimation apparatus 1 may be referred to as a video quality estimation apparatus 1.

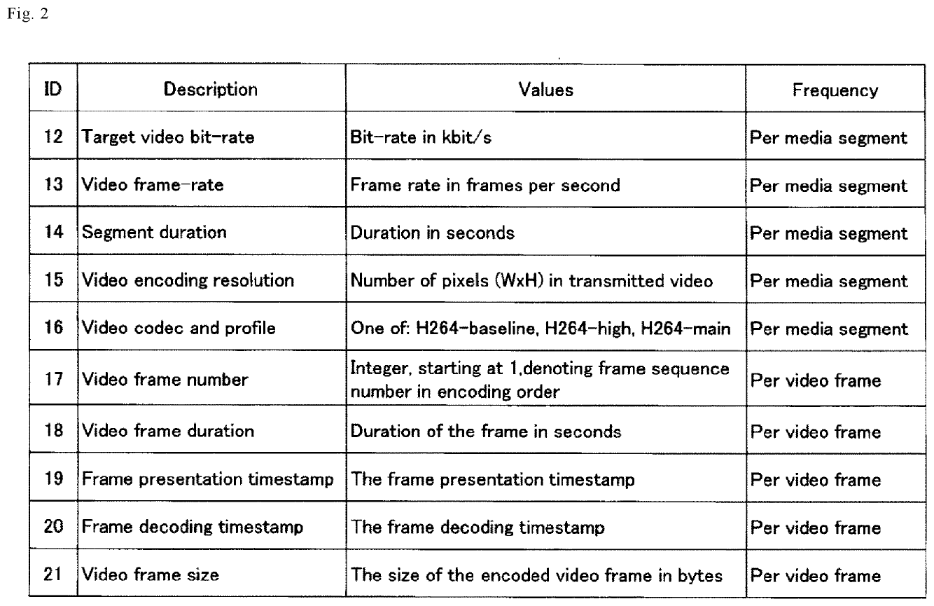

The high image quality region video quality estimation unit 11 calculates a high image quality region video quality estimation value for viewing for a few seconds to a few tens of seconds with an input of a video parameter of a high image quality region. An example of the video parameters of the high image quality region is illustrated in FIG. 2.

As illustrated in FIG. 2, bit-rate, frame rate, resolution, and the like are used as input parameters.

The high image quality region video quality estimation unit 11 calculates the high image quality region video quality estimation value using, for example, the following equations.

O.22_{H}=MOSq

MOSq=q₁+q₂#exp(q₃·quant)

quant=a₁+a₂·ln(a₃+ln(br)+ln(br·bpp))

$$bpp = \frac{br}{res \cdot fr} \qquad [ Math . 1 ]$$

Here, O.22_{H} represents a high image quality region video quality estimation value, br represents a bit-rate, res represents a resolution, fr represents a frame rate, and q₁ to q₃ and a₁ to a₃ are predetermined constants.

The high image quality region video quality estimation unit 11 may calculate the high image quality region video quality estimation value as follows using the above-mentioned MOSq in the same manner as in NPL 7.

O.22_{H}=MOSfromR(100−D)

D=max(min(D_{q}+Dᵤ+Dₜ,100),0)

D_{q}=max(min(100−RfromMOS(MOSq),100),0)

Dᵤ=max(min(u₁·log₁₀(u₂·(scaleFactor−1)+1),100,0)

$$scaleFactor = max ( \frac{disRes}{codRes} , 1 ) \\ {D}_{t} = \{ \begin{matrix}max ( min ( {D}_{t 1} - {D}_{t 2} - {D}_{t 3} , 100 ) , 0 ) , framerate < 24 \\ 0 , framerate \geq 24\end{matrix} \\ {D}_{t 1} = \frac{100 \cdot ( {t}_{1} - {t}_{2} \cdot framerate )}{{t}_{3} + framerate} \\ {D}_{t 2} = \frac{Dq \cdot ( {t}_{1} - {t}_{2} \cdot framerate )}{{t}_{3} + framerate} \\ {D}_{t 3} = \frac{Du \cdot ( {t}_{1} - {t}_{2} \cdot framerate )}{{t}_{3} + framerate} \qquad [ Math . 2 ]$$

Here, MOSfromR and RfromMOS represent functions that convert a user experienced quality MOS and a psychological value R described in NPL 7, disRes represents a display resolution, codRes represents a coding resolution, and u₁, u₂, and t₁ to t₃ represent predetermined constants. In addition, D represents a quality degradation amount (Degradation).

The low image quality region video quality estimation unit 12 calculates a low image quality region video quality estimation value with an input of video parameters of low image quality regions, similarly to the high image quality region video quality estimation unit 11. The low image quality region video quality estimation value is also a quality estimation value for viewing for a few seconds to a few tens of seconds.

However, when the procedure described in NPL 7 is used in calculating the high image quality region video quality estimation value or the low image quality region video quality estimation value, it is desirable to appropriately re-set each coefficient used in the calculation in consideration of differences between the video service targeted in NPL 7 and the VR video service and differences in display devices.

The video quality estimation unit 13 calculates a video quality estimation value based on the high image quality region video quality estimation value calculated by the high image quality region video quality estimation unit 11 and the low image quality region video quality estimation value calculated by the low image quality region video quality estimation unit 12. When the high image quality region video quality estimation value, the low image quality region video quality estimation value, and the video quality estimation value are O.22_{H}, O.22_{L}, and O.22, respectively, the video quality estimation value can be calculated using the following calculation equation.

O.22=α·O.22_{H}+β·O.22_{L}

In the above equation, a and R are predetermined coefficients. The video quality estimation value O.22 is also a quality estimation value for viewing for a few seconds to a few tens of seconds.

The audio quality estimation unit 14 calculates an audio quality estimation value for viewing of about a few seconds to a few tens of seconds with an input of an audio parameter. The audio quality estimation value can be calculated using the following equation, for example, in the same manner as described in NPL 8.

O.21=a_{1A}·exp(a_{2A}·Br_{A})+a_{3A}

Here, O.21 represents an audio quality estimation value, br_{A} represents a bit-rate of audio, and a_{1A} to a_{3A} represent predetermined constants.

The quality integration unit 23 including the AV quality/quality variation integration unit 21 and the replay-stop-caused degradation amount estimation unit 22 calculates a quality estimation value with inputs of the video quality estimation value, the audio quality estimation value, a replay stop parameter, and the device type.

The AV quality/quality variation integration unit 21 calculates a short-time AV quality estimation value O.34 for viewing of about a few seconds to a few tens of seconds with the video quality estimation value and the audio quality estimation value.

Furthermore, the AV quality/quality variation integration unit 21 calculates a long-time AV quality estimation value O.35 for viewing of about a few minutes in consideration of quality variation associated with changes of a band over time. Further, in the present specification, the time of about a few seconds to a few tens of seconds is referred to as “a short time”, and the time of about a few minutes is referred to as “a long time”.

The AV quality/quality variation integration unit 21 can calculate O.34 in the following equation, for example, similarly to the procedure described in NPL 9.

O.34ₜ=max(min(av₁+av₂·O.21ₜ+av₃·O.22ₜ+av₄·O.21ₜ·O.22ₜ,5),1)

Here, O.34ₜ represents an AV quality estimation value at a time t, O.21ₜ represents an audio quality estimation value at the time t, O.22ₜ represents a video quality estimation value at the time t, and av₁ to av₄ represent predetermined constants.

In addition, the AV quality/quality variation integration unit 21 can calculate the AV quality estimation value O.35 for a media session using the following equation similarly to the procedure described in NPL 9, for example.

$$O {\text{.35}}_{baseline} = \frac{{\sum }_{t} {w}_{1} ( t ) \cdot {w}_{2} ( t ) \cdot O {\text{.34}}_{t}}{{\sum }_{t} {w}_{1} ( t ) \cdot {w}_{2} ( t )} \\ {w}_{1} ( t ) = {t}_{1} + {t}_{2} \cdot exp ( \frac{t - 1}{T \cdot {t}_{3}} ) \\ {w}_{2} ( t ) = {t}_{4} - {t}_{5} \cdot O {\text{.34}}_{t} \qquad [ Math . 3 ]$$

Here, O.35 represents the AV quality estimation value. O.34ₜ represents the AV quality estimation value at the time t, T represents the target time length of the AV quality estimation value O.35, and t₁ to t₅ represent predetermined constants. Although negBias, oscComp, and adaptComp are variables representing the influence of the width and frequency of quality variation, the calculation may be omitted, in which case O.35 is equal to O.35_{baseline}.

The replay-stop-caused degradation amount estimation unit 22 calculates a replay-stop-caused degradation amount SI from replay stop parameters. The replay-stop-caused degradation amount SI can be calculated using the following equation, for example, similarly to the procedure described in NPL 9.

$$SI = exp ( - \frac{numStalls}{{s}_{1}} ) \cdot exp ( - \frac{totalStallLen}{T \cdot {s}_{2}} ) \cdot exp ( - \frac{avgStallInterval}{T \cdot {s}_{3}} ) \qquad [ Math . 4 ]$$

Here, numStalls represents the number of replay stops, totalStallLen represents the sum of replay stop times, avgStallInterval represents the average interval of the occurrence of replay stops occur, T represents the target time length of the AV quality estimation value (and SI), and s₁ to s₃ represent predetermined constants.

The quality integration unit 23 calculates the quality estimation value O.46 from the AV quality estimation value O.35 and the replay-stop-caused degradation amount SI. The quality estimation value can be calculated using the following equation, for example, similarly to the procedure described in NPL 9.

O.46=O.02833052+O.98117059·O.46ₜₑₘₚ

O.46ₜₑₘₚ=O.75·(1+(O.35−1)·SI)+O.25·RFPrediction

Here, RFPrediction represents a quality estimation value calculated using the random forests described in NPL 9. The quality estimation value O.46 can be calculated as below by omitting the calculation of the random forest.

O.46=1+(O.35−1)·SI

When the short-time AV quality estimation value O.34, the long-time AV quality estimation value O.35, the replay-stop-caused degradation amount SI, and the quality estimation value O.46 are calculated through the procedure of NPL 9 in the operations described above, it is desirable to appropriately re-set each coefficient used in the calculation in consideration of differences between the video service targeted in NPL 9 and the VR video service and differences in display devices. At that time, the parameter of the device type described above may be used, for example.

Example of Hardware Configuration

The VR video quality estimation apparatus 1 may be implemented by hardware using, for example, a logic circuit that realizes the functions of each part illustrated in FIG. 1, or may be implemented by causing a general-purpose computer to execute a program in which processing content described in the first and second embodiments is described. Further, the “computer” may be a virtual machine. When a virtual machine is used, the “hardware” mentioned here is virtual hardware.

When the computer is used, the VR video quality estimation apparatus 1 can be implemented by executing a program corresponding to processing performed by the VR video quality estimation apparatus 1 using hardware resources such as a CPU and a memory mounted in the computer. The program can be recorded on a computer-readable recording medium (a portable memory or the like) to be stored or distributed. The program can also be provided via a network such as the Internet or an e-mail.

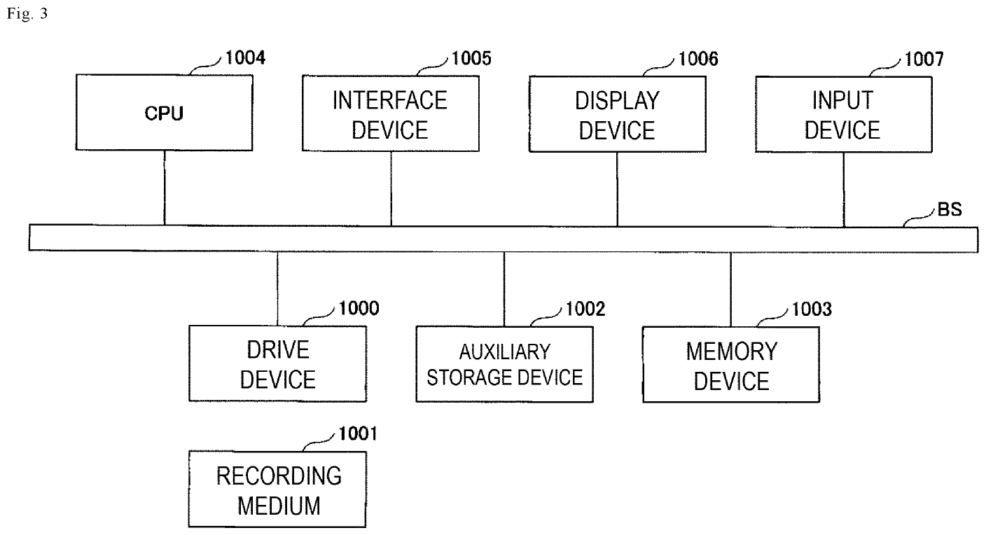

FIG. 3 is a diagram illustrating an example of a hardware configuration of the above-described computer. The computer in FIG. 3 includes a drive device 1000, an auxiliary storage device 1002, a memory device 1003, a CPU 1004, an interface device 1005, a display device 1006, and an input device 1007 connected to each other via a bus B.

A program for implementing processing in the computer is provided by, for example, a recording medium 1001 such as a CD-ROM or a memory card. When the recording medium 1001 storing the program is set in the drive device 1000, the program is installed in the auxiliary storage device 1002 from the recording medium 1001 via the drive device 1000. However, the program may not necessarily be installed from the recording medium 1001 and may be downloaded from another computer via a network. The auxiliary storage device 1002 stores the installed program and also stores a necessary file, data, and the like.

The memory device 1003 reads the program from the auxiliary storage device 1002 and stores the program when an instruction to activate the program is given. The CPU 1004 implements functions related to the VR video quality estimation apparatus 1 in accordance with the program stored in the memory device 1003. The interface device 1005 is used as an interface connected to the network. The display device 1006 displays a graphical user interface (GUI) or the like according to the program. The input device 1007 includes a keyboard, a mouse, buttons, a touch panel, and the like, and is used to input various operation instructions.

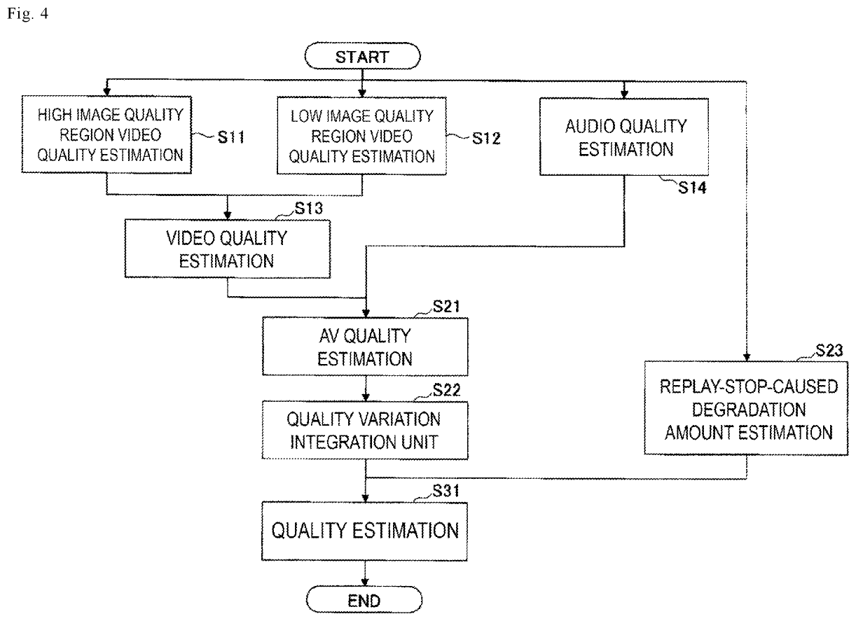

Processing Procedure of VR Video Quality Estimation Apparatus 1 Hereinafter, a processing procedure performed by the VR video quality estimation apparatus 1 will be described. FIG. 4 is a flowchart for describing an example of the processing procedure performed by VR video quality estimation apparatus 1.

In 511, the high image quality region video quality estimation unit 11 calculates a high image quality region video quality estimation value based on video parameters of high image quality regions. In S12, the low image quality region video quality estimation unit 12 calculates a low image quality region video quality estimation value based on video parameters of low image quality regions.

In S13, the video quality estimation unit 13 calculates a video quality estimation value (e.g., O.22) based on the high image quality region video quality estimation value and the low image quality region video quality estimation value. In 514, the audio quality estimation unit 14 calculates an audio quality estimation value (e.g., O.21).

In S21, the AV quality/quality variation integration unit 21 calculates a short-time AV quality estimation value (e.g., O.34) based on the video quality estimation value and the audio quality estimation value. In S22, the AV quality/quality variation integration unit 21 calculates an AV quality estimation value (e.g., O.35) based on the short-time AV quality estimation value.

In S23, the replay-stop-caused degradation amount estimation unit 22 calculates a replay-stop-caused degradation amount (e.g., SI). In S31, the quality integration unit 23 calculates and outputs a quality estimation value (e.g., O.46) based on the AV quality estimation value and the replay-stop-caused degradation amount and ends the processing.

### Second Embodiment

Next, the second embodiment will be described. Differences of the second embodiment from the first embodiment will be described below.

A difference of the second embodiment from the first embodiment is that the high image quality region video quality estimation unit 11 and the low image quality region video quality estimation unit 12 output quality degradation amounts, and the video quality estimation unit 13 calculates a video quality estimation value based on the quality degradation amounts.

For example, using the equations shown in the first embodiment, the high image quality region video quality estimation unit 11 and the low image quality region video quality estimation unit 12 output D_{qH}, D_{uH}, D_{tH}, D_{qL}, D_{uL}, and D_{tL}. Here, D_{g}, Dᵤ, and Dₜ output by the high image quality region video quality estimation unit 11 are denoted by D_{qH}, D_{uH}, and D_{tH}, and D_{g}, Dᵤ, and Dₜ output by the low image quality region video quality estimation unit 12 are denoted by D_{qL}, D_{uL}, and D_{tL}. Further, all of D_{qH}, D_{uH}, and D_{tH} indicating quality degradation amounts are examples of the high image quality region video quality estimation value, and all of D_{qL}, D_{uL}, and D_{tL} are examples of the low image quality region video quality estimation value.

The video quality estimation unit 13 can calculate a video quality estimation value (O.22) using the following equation.

O.22=MOSfromR(100−D_{HL})

D_{HL}=max (min (α₁·D_{qH}+α₂·D_{uH}+α₃·D_{tH}+β₁·D_{qL}+β₂·D_{uL}+Φ₃·D_{tL}, 100), 0) Here, α₁ to α₃ and β₁ to β₃ are predetermined constants.

Effects of Embodiment, Etc.

As described above, the present embodiment provides the VR video quality estimation apparatus 1 that estimates the quality of a tile-based VR video experienced by a user when viewing the VR video.

The VR video quality estimation apparatus 1 includes the video quality estimation unit 13 that estimates a video quality based on a parameter related to video quality of a high image quality region and a parameter related to video quality of a low image quality region, an audio quality estimation unit 14 that estimates audio quality from a parameter related to an audio quality, an AV quality/quality variation integration unit 21 that estimates short-time AV quality and long-time AV quality based on a video quality estimation value calculated by the video quality estimation unit 13 and an audio quality estimation value calculated by the audio quality estimation unit 14, the replay-stop-caused degradation amount estimation unit 22 that estimates a degradation amount of an experienced quality based on a parameter related to the stop of replay, the degradation caused by a stop of replay, and a quality integration unit 23 that estimates the experienced quality for viewing based on the long-time AV quality calculated by the AV quality/quality variation integration unit 22 and the replay-stop-caused degradation amount calculated by the replay-stop-caused degradation amount estimation unit 22.

The VR video quality estimation apparatus 1 may include the high image quality region video quality estimation unit 11 that estimates video quality of a high image quality region based on parameters related to the video quality of the high image quality region, and the low image quality region video quality estimation unit 12 that estimates video quality of a low image quality region based on parameters related to the video quality of the low image quality region. In this case, the video quality estimation unit 13 calculates a video quality estimation value based on a high image quality region video quality estimation value calculated by the high image quality region video quality estimation unit 11 and a low image quality region video quality estimation value calculated by the low image quality region video quality estimation unit 12.

The VR video quality estimation apparatus 1 according to the present embodiment can estimate the experienced quality in viewing taking quality degradation associated with movement of the line of sight into account, by considering the video quality of the high image quality region and the video quality of the low image quality region of the tile-based VR video service calculated using the parameters.

Summary of Embodiment

This specification describes at least a video quality estimation apparatus, a video quality estimation method, and a program described in the following paragraphs.

### Paragraph 1

A video quality estimation apparatus for estimating a quality experienced by a user when viewing a video includes
a video quality estimation unit that estimates a video quality based on a parameter related to video quality of a high image quality region in the video and a parameter related to video quality of a low image quality region in the video,
an audio quality estimation unit that estimates audio quality from a parameter related to audio quality of the video,
an audio-visual quality/quality variation integration unit that estimates audio-visual quality based on a video quality estimation value estimated by the video quality estimation unit and an audio quality estimation value estimated by the audio quality estimation unit,
a degradation amount estimation unit that estimates a degradation amount of the experienced quality based on a parameter related to the stop of replay of the video, the degradation caused by a stop of replay, and
a quality integration unit that estimates the experienced quality in viewing based on the audio-visual quality estimated by the audio-visual quality/quality variation integration unit and the degradation amount caused by the stop of replay estimated by the degradation amount estimation unit.

### Paragraph 2

The video quality estimation apparatus described in paragraph 1 further including a high image quality region video quality estimation unit that estimates video quality of the high image quality region based on the parameter related to the video quality of the high image quality region, and
a low image quality region video quality estimation unit that estimates video quality of the low image quality region based on the parameter related to the video quality of the low image quality region,
in which the video quality estimation unit calculates the video quality estimation value based on a high image quality region video quality estimation value estimated by the high image quality region video quality estimation unit and a low image quality region video quality estimation value estimated by the low image quality region video quality estimation unit.

### Paragraph 3

The video quality estimation apparatus described in paragraph 1 or 2, in which the audio-visual quality/quality variation integration unit estimates short-time audio-visual quality for short-time viewing based on the video quality estimation value estimated by the video quality estimation unit, and estimates the audio-visual quality based on the short-time audio-visual quality.

### Paragraph 4

The video quality estimation apparatus described in any of paragraphs 1 to 3, in which the video that a user views is a tile-based VR video.

### Paragraph 5

A video quality estimation method performed by a video quality estimation apparatus for estimating a quality experienced by a user when viewing a video, the video quality estimation method including
a video quality estimation step of estimating a video quality based on a parameter related to video quality of a high image quality region in the video and a parameter related to video quality of a low image quality region in the video,
an audio quality estimation step of estimating audio quality from a parameter related to audio quality of the video,
an audio-visual quality/quality variation integration step of estimating audio-visual quality based on a video quality estimation value estimated in the video quality estimation step and an audio quality estimation value estimated in the audio quality estimation step,
a degradation amount estimation step of estimating a degradation amount of the experienced quality based on a parameter related to the stop of replay of the video, the degradation being caused by a stop of replay, and
a quality integration step of estimating the experienced quality in viewing based on the audio-visual quality estimated in the audio-visual quality/quality variation integration step and the degradation amount caused by the stop of replay estimated in the degradation amount estimation step.

### Paragraph 6

A program for causing a computer to function as a unit of the video quality estimation apparatus described in any one of paragraphs 1 to 4.

Although the present embodiments have been described above, the present invention is not limited to the specific embodiments, and various modifications and changes can be made within the scope of the gist of the present invention described in the claims.

### REFERENCE SIGNS LIST

1 VR video quality estimation apparatus
11 High image quality region video quality estimation unit
12 Low image quality region video quality estimation unit
13 Video quality estimation unit
14 Audio quality estimation unit
21 AV quality/quality variation integration unit
22 Replay-stop-caused degradation amount estimation unit
23 Quality integration unit
1000 Drive device
1001 Recording medium
1002 Auxiliary storage device
1003 Memory device
1004 CPU
1005 Interface device
1006 Display device
1007 Input device

1. A video quality estimation apparatus for estimating a quality experienced by a user when viewing a video comprising:
a video quality estimation unit, including one or more processors, configured to estimate a video quality based on a parameter related to video quality of a high image quality region in the video and a parameter related to video quality of a low image quality region in the video,
an audio quality estimation unit, including one or more processors, configured to estimate audio quality from a parameter related to audio quality of the video;
an audio-visual quality/quality variation integration unit, including one or more processors, configured to estimate audio-visual quality based on a video quality estimation value estimated by the video quality estimation unit and an audio quality estimation value estimated by the audio quality estimation unit;
a degradation amount estimation unit, including one or more processors,
configured to estimate a degradation amount of the experienced quality based on a parameter related to the stop of replay of the video, the degradation being caused by a stop of replay; and
a quality integration unit, including one or more processors, configured to estimate the experienced quality in viewing based on the audio-visual quality estimated by the audio-visual quality/quality variation integration unit and the degradation amount caused by the stop of replay estimated by the degradation amount estimation unit.

2. The video quality estimation apparatus according to claim 1, further comprising:
a high image quality region video quality estimation unit, including one or more processors, configured to estimate video quality of the high image quality region based on the parameter related to the video quality of the high image quality region; and
a low image quality region video quality estimation unit, including one or more processors, configured to estimate video quality of the low image quality region based on the parameter related to the video quality of the low image quality region,
wherein the video quality estimation unit is configured to calculate the video quality estimation value based on a high image quality region video quality estimation value estimated by the high image quality region video quality estimation unit and a low image quality region video quality estimation value estimated by the low image quality region video quality estimation unit.

3. The video quality estimation apparatus according to claim 1,
wherein the audio-visual quality/quality variation integration unit is configured to estimate short-time audio-visual quality for short-time viewing based on the video quality estimation value estimated by the video quality estimation unit, and estimate the audio-visual quality based on the short-time audio-visual quality.

4. The video quality estimation apparatus according to claim 1,
wherein the video that a user views is a tile-based VR video.

5. A video quality estimation method performed by a video quality estimation apparatus for estimating a quality experienced by a user when viewing a video, the video quality estimation method comprising:
a video quality estimation step of estimating a video quality based on a parameter related to video quality of a high image quality region in the video and a parameter related to video quality of a low image quality region in the video,
an audio quality estimation step of estimating audio quality from a parameter related to audio quality of the video;
an audio-visual quality/quality variation integration step of estimating audio-visual quality based on a video quality estimation value estimated in the video quality estimation step and an audio quality estimation value estimated in the audio quality estimation step;
a degradation amount estimation step of estimating a degradation amount of the experienced quality based on a parameter related to the stop of replay of the video, the degradation being caused by a stop of replay; and
a quality integration step of estimating the experienced quality in viewing based on the audio-visual quality estimated in the audio-visual quality/quality variation integration step and the degradation amount caused by the stop of replay estimated in the degradation amount estimation step.

6. A non-transitory computer readable medium storing a program for causing a computer to function as a unit of a video quality estimation apparatus for estimating a quality experienced by a user when viewing a video, to perform:
a video quality estimation step of estimating a video quality based on a parameter related to video quality of a high image quality region in the video and a parameter related to video quality of a low image quality region in the video,
an audio quality estimation step of estimating audio quality from a parameter related to audio quality of the video;
an audio-visual quality/quality variation integration step of estimating audio-visual quality based on a video quality estimation value estimated in the video quality estimation step and an audio quality estimation value estimated in the audio quality estimation step;
a degradation amount estimation step of estimating a degradation amount of the experienced quality based on a parameter related to the stop of replay of the video, the degradation being caused by a stop of replay; and
a quality integration step of estimating the experienced quality in viewing based on the audio-visual quality estimated in the audio-visual quality/quality variation integration step and the degradation amount caused by the stop of replay estimated in the degradation amount estimation step.

7. The non-transitory computer readable medium according to claim 6,
wherein the computer is further caused to perform:
estimating video quality of the high image quality region based on the parameter related to the video quality of the high image quality region; and
estimating video quality of the low image quality region based on the parameter related to the video quality of the low image quality region,
wherein the video quality estimation step comprising calculating the video quality estimation value based on a high image quality region video quality estimation value estimated by the high image quality region video quality estimation unit and a low image quality region video quality estimation value estimated by the low image quality region video quality estimation unit.

8. The non-transitory computer readable medium according to claim 6,
wherein the audio-visual quality/quality variation integration step comprising estimating short-time audio-visual quality for short-time viewing based on the video quality estimation value estimated by the video quality estimation unit, and estimates the audio-visual quality based on the short-time audio-visual quality.

9. The non-transitory computer readable medium according to claim 6,
wherein the video that a user views is a tile-based VR video.

10. The video quality estimation method according to claim 5, further comprising:
estimating video quality of the high image quality region based on the parameter related to the video quality of the high image quality region; and
estimating video quality of the low image quality region based on the parameter related to the video quality of the low image quality region,
wherein the video quality estimation step comprising calculating the video quality estimation value based on a high image quality region video quality estimation value estimated by the high image quality region video quality estimation unit and a low image quality region video quality estimation value estimated by the low image quality region video quality estimation unit.

11. The video quality estimation method according to claim 5,
wherein the audio-visual quality/quality variation integration step comprising estimating short-time audio-visual quality for short-time viewing based on the video quality estimation value estimated by the video quality estimation unit, and estimates the audio-visual quality based on the short-time audio-visual quality.

12. The video quality estimation method according to claim 5,
wherein the video that a user views is a tile-based VR video.
